(19) United States
(12) Patent Application Publication
(10) Pub. No.: US 2008/0040845 A1
(43) Pub. Date: Feb. 21, 2008

(54) Exhibiting Device for Advertisements

(76) Inventor: Oren Shoshan, Tel Aviv (IL)

Correspondence Address: YORAM TSIVION, P.O. BOX 1307, PARDES HANNA, 37111, IL

(21) Appl. No.: 11/813,219

(22) PCT Filed: Dec. 28, 2005
(86) PCT No.: PCT/IL05/01386

§ 371 Date: Jul. 2, 2007

(30) Foreign Application Priority Data
Dec. 30, 2004 (IL) 166064

(51) Int. Cl. A47K 17/00; A63F 9/24

(52) U.S. Cl. 4/314

(57) ABSTRACT

A system for exhibiting visual and audio media in or on a toilet bowl, cover and seat, provides for displaying a compound message including visual graphics, text, audible content and or sound and music. The system consists of visual graphic items such as drawings, two and/or three dimensional pictures, a controller including a processor serving at least as an audio generator, light emitting diodes, and loud speakers. The graphic items are attachable to the toilet cover, the face of a toilet bowl and/or a flushing tank, and/or are embedded in the toilet seat. The system is activated by means of a 3600 motion detection sensor that activates the system upon detection of motion. A power supply including a rechargeable battery embedded in the toilet cover or seat powers the system.

### TECHNICAL FIELD OF THE INVENTION

The present invention is in the general field of advertising. More specifically it relates to indoor advertising.

### BACKGROUND OF THE INVENTION

Toilets of public institutions have been considered suitable for advertising. Japanese patent application 5065731A2 discloses an apparatus for odor removal from a toilet in which its front face is used for displaying an advertisement. A Korean patent 2043145A discloses a toilet seat, which is sterilized by UV radiation and is capable of sounding an auditory advertisement to a user. U.S. Pat. No. 6,779,206 discloses a toilet or urinal facility having a screen for displaying video. A sensor detects the presence of a person in the facility in order to activate the advertisement or announce a message. U.S. Pat. No. 6,138,292 discloses a cover used for commercial advertising, for the flush handle of toilets and urinals, where printed matter, which illustrates a particular advertisement, is inserted. US patent application 21037520A1 discloses a toilet seat with flashing light, heater and music functions in which a graphics item can also be inserted.

### SUMMARY OF THE INVENTION

The present invention provides a method and a system for exhibiting a compound message by using a toilet facility. Illuminating visual graphics items and sounding utterances, spoken message, music or any combination thereof exhibits the compound message. The visual graphics items consist of text, drawings, two-dimensional pictures, three-dimensional pictures or any combination thereof. At least one of the visual graphics item is attached to the inner face of the toilet cover and/or the face of the flushing tank, and/or the front of the toilet bowl. The system controller activates the illumination and sound. Illumination is effected by light emitting devices (LED) controlled by the system controller, which is located in the cover or in the toilet seat.

Another aspect of the present invention is a showcase suitable for indoor advertising in general. The showcase consists of a transparent face behind which at least one visual graphic item is disposed. The system controller, at least one speaker and a battery are also installed inside the showcase. A magnetic element at the back of the showcase facilitates attachment to some metallic surfaces.

### BRIEF DESCRIPTION OF THE DRAWINGS

FIG. 1 is a front view of a preferred embodiment of a system for exhibition of media in a toilet bowl cover and seat (CAS), according to the present invention;

FIG. 2 is a front view of another preferred embodiment of a system for exhibiting in a toilet bowl CAS, according to the present invention;

FIG. 3 is a longitudinal section in the cover of FIG. 1;

FIG. 4 is a longitudinal section of a showcase, according to another preferred embodiment of the present invention;

FIG. 5 is an isometric view of another preferred embodiment of a system for exhibiting in a toilet bowl CAS, according to the present invention;

### DETAILED DESCRIPTION OF THE PRESENT INVENTION

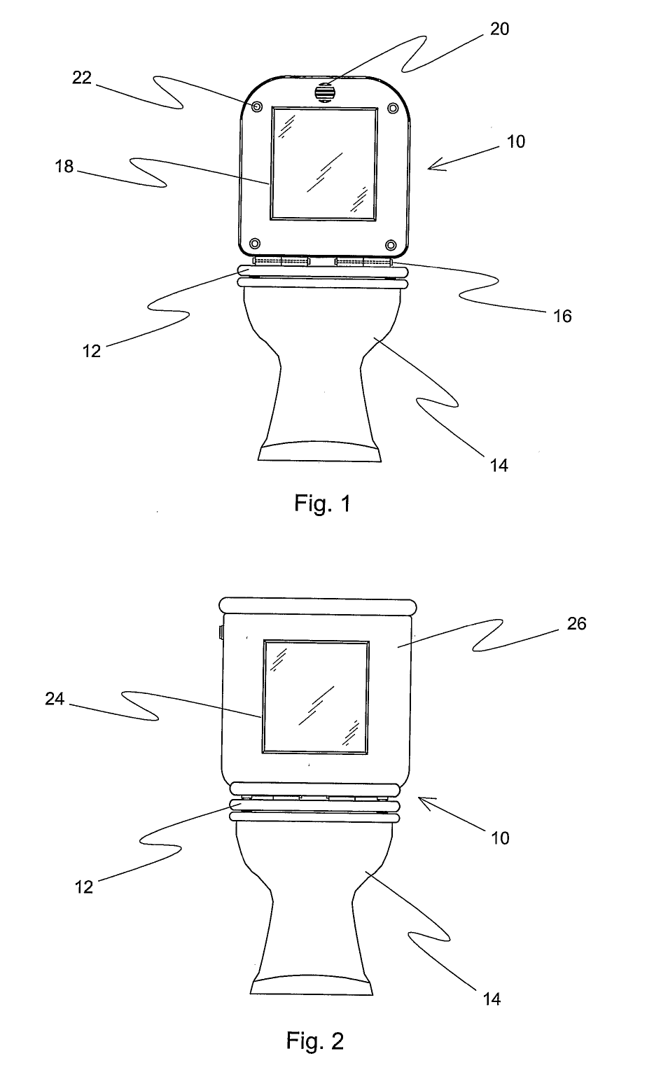

The various aspects of the present invention are explained with reference to FIGS. 1-5. In FIG. 1 a preferred embodiment of the invention in a toilet bowl cover and seat (CAS), is shown. Toilet cover 10 and seat 12 are pivotally attached to toilet bowl 14 by means of pneumatic hinges 16. The pneumatic hinges function as shock absorbers for dampening the closing of the toilet seat into a sitting position, and/or the closing of the toilet cover.

Visual graphics 18 is attached to the inner face of the toilet cover. This visual graphics item constitutes the graphical aspect of a compound message to be exhibited by the toilet CAS of the invention. It consists of text, drawings or two (2D) or three dimensional (3D) pictures or, or any combination thereof. It may be associated with products, services, and/or activities to be promoted and advertised by means of the toilet CAS. The visual graphics item of the present invention is any colored, black and white printed transparency, regular paper or electronic paper. Transparencies generated by chemical etching or laser engraving are also acceptable as visual graphics items. The graphical aspect of the compound message of the present invention typically consists of 2D, and/or 3D still pictures, animation and/or video clips and any combination thereof.

Speaker 20, is disposed in association with cover 10, and connected to an associated audio generator, not shown, provides for the audible aspect of the compound message. A sensing device consisting of a micro-switch, not shown, attached to one of hinges 16, enables the exhibition of the compound message when the cover is open. Flexible spacers 22 absorb mechanical impact caused by shutting of cover 10. For a similar purpose, flexible spacers are attached to the bottom of the seat 12.

Another preferred embodiment of a system for exhibition of media in a toilet bowl CAS, which is suitable for a mono-block structure, in which the flush tank is installed on top of the toilet bowl, is shown in FIG. 2. Here -visual graphics item 24 is attached to the front face of flush tank 26.

The audible aspect of the compound message is any sound, such as utterance, spoken message, music or any combination thereof. A system controller, not shown, which is installed inside cover 10 activates exhibiting the compound message by illuminating the visual graphic items and sounding the audible content.

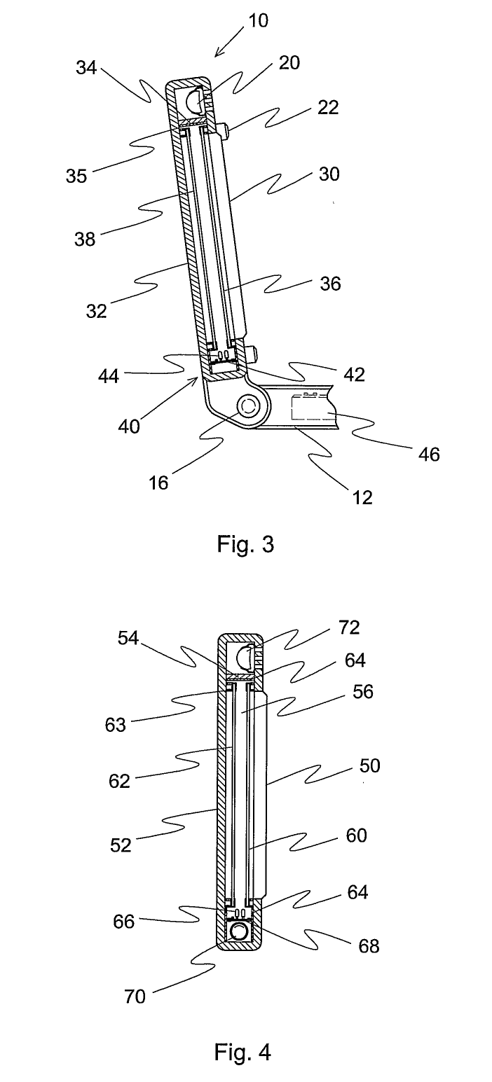

In FIG. 3, a longitudinal section in toilet cover 10 is shown. This toilet cover serves as a showcase in which a compound message is exhibited. Transparent front face 30, back wall 32 and sidewall 34 form an internal volume of toilet cover 10. Inner face 35 of sidewall 34 is coated with a light reflective coating, so that light impinging on it is reflected into the internal volume of the cover. A visual graphic printed over transparency 36 is disposed behind transparent front face 30. Additional visual graphic item 38 is located in front of the back wall spaced apart from transparency 36. System controller 40 is located at the bottom of the internal volume of toilet cover 10. The system controller consists of printed circuit board (PCB) 42, light emitting devices (LED) 44 and a processor, not shown, and is attached to PCB 42. Light emitted by LED 44 illuminates the back of transparency 36 and the face of the additional visual graphics item 38. This illumination in combination with the two visual graphics items, the distance between them and optical structures on the front surface of transparent face 30, are all parameters that define visual properties of an image that an observer can view. Rechargeable battery 46 such as a lithium battery, installed inside toilet seat 12 powers the system controller. Charging of the battery is for safety purposes induced by an external power supply, which can be connected to the main power supply of the building or to a solar cell, not shown.

The audible aspect of the compound message consists of spoken message, sound, music and any combination thereof. It is digitized and stored in the processor memory and the processor further activates sound as an audio generator by feeding the speakers with signals generated employing this stored content.

Activation of the exhibition of the compound message is possible by means of a motion detector, which is attached to the lavatory ceiling and may activate the system controller. Other schemes of activation are plausible, also in accord with the present invention, such as by illumination and sound.

Some embodiments of the present invention employ visual graphic items attached to the face of flushing tank, inner face of the toilet cover, front face of the toilet bowl and any combination thereof. Visual graphics items may be directly attached to the corresponding surfaces of these parts and/or by employing a dedicated showcase as can be explained by reference to FIG. 4. In FIG. 4 a longitudinal section of a showcase of the present invention is shown. The showcase consists of transparent front face 50, back wall 52 and sidewall 54 forming together an internal volume 56. One or two graphics items 60 and 62, are inserted into slots 64 to get 2D or 3D pictures accordingly. LED 66 connected to PCB 68, which is located at the bottom of the internal volume 56, illuminate the face of visual graphics item 62 if present, and the back of visual graphics item 60. An illuminating light impinging reflective coating 64 over the inner surface of sidewall 54 is reflected into the internal volume 56 to enhance the image seen through the transparent face 50. A processor, connected to PCB 68, is typically employed in such applications as exhibiting a compound message. Such applications require battery 70, which is installed typically inside the showcase and is connected to PCB 68. Such applications typically also require speaker 72, which is connected to the processor, not shown. The user, by means of a touch key located aside the speaker, not shown, activates the illumination and sound in such applications.

The showcase can be attached to any surface of wall, furniture, equipment, or the toilet bowl, cover and flush tank, by means of screws, or an attachable surface coated with glue, or magnetically, suitable in cases that the attachment is to some metallic walls of equipment or furniture. The LED 66 may be also operated by an outside controller such as the system controller located at the toilet cover, as described above.

In some variants of the present invention Illuminating the visual graphics items is only effected by an outside light source. Such an outside source is for example a LED installed inside a transparent toilet seat illuminating the visual graphics item attached to the inner face of the toilet cover. In such cases the system controller is also installed in the toilet seat. Similarly LED installed inside a transparent toilet cover may illuminate visual graphics item, which is attached to the flush tank.

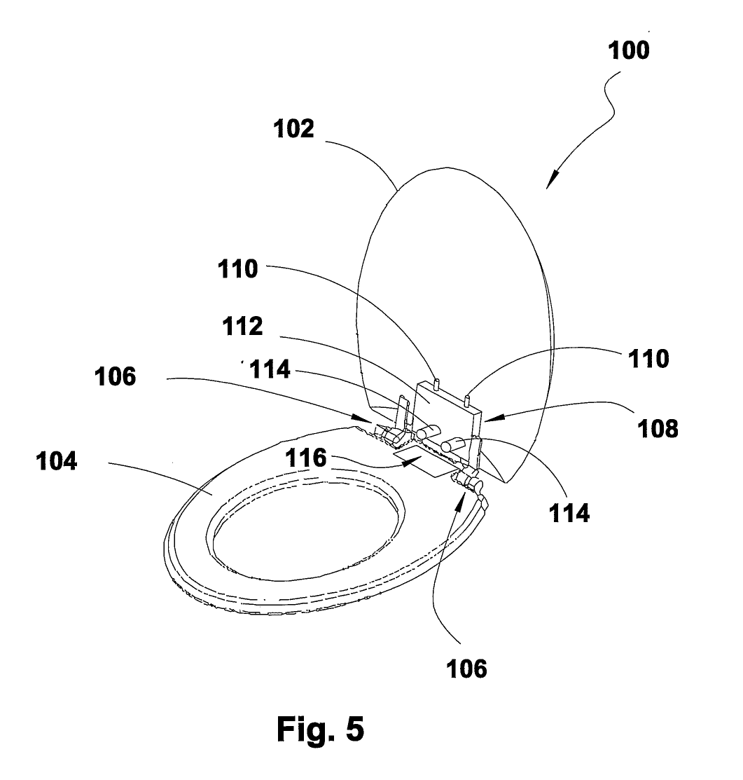

Another way of installing the system controller in a toilet CAS is described with reference to FIG. 5 in another preferred embodiment of a toilet bowl CAS of the invention. CAS 100, including rear wall of a toilet cover 102 attached to 104 by hinges 106. The front wall is omitted from the drawing of the toilet cover in order to expose the internal volume of the cover. Control box 112 is attached in front of the rear wall of cover 102 at its bottom. Two LED units 110 upwardly protruding from the upper face of the system controller illuminate the internal volume of the toilet cover. Two other LED units 114 protrude forwards from the front wall of the bottom of system controller 112. Transparent upper face portion 116 lets light emitted from these two lower LED units illuminate the front surface of the toilet cover.

The present invention provides a method for advertising and promoting sales of products, services and activities. Lavatories, particularly in public places are visited by a variety of people, which may be quite large. Therefore making an appeal to the public and drawing attention of the individuals to the compound message made available by the method of the invention potentially provide a substantial impact.

The showcase of the invention preferably with the magnetic attachment means, may be quite attractive to users who are fond of electronic gadgets and toys. Therefore it can be also used as a gift given for free or selectively mailed to group of potential customers.

1. A system for exhibiting in a toilet bowl cover and seat (CAS), comprising:
at least one speaker associated with said cover;
at least one visual graphics item selected from the group containing text, drawings, two dimensional (2D) pictures, three dimensional (3D) pictures and any combination thereof, wherein said at least one visual graphics item is associated with said CAS, and wherein said at least one visual graphics item is attached to any part selected from the group containing an inner face of said cover, a front face of said toilet bowl, a front face of a flushing tank;
a controller attached to any item of a group including: said cover and said seat, wherein said controller further comprising:
a processor serving at least as an audio generator for feeding signals to said at least one speaker, and
at least one light emitting device (LED) illuminating said at least one visual graphics item.

2. A system for exhibiting in a toilet bowl CAS as in claim 1, wherein at least a part of said inner face of said toilet cover is transparent, and wherein at least one visual graphics item is disposed behind said inner face of said cover.

3. A system for exhibiting in a toilet bowl CAS as in claim 2, wherein said inner face is spaced apart from a rear wall of said toilet cover forming an internal volume of said toilet cover illuminated by said at least one LED.

4. A system for exhibiting in a toilet bowl CAS as in claim 1, wherein said cover and said seat are pivotally coupled to said bowl by pneumatic hinges dampening the swiveling of at least said cover.

5. A system for exhibiting in a toilet bowl CAS as in claim 3, wherein said at least one visual graphics item is a transparency.

6. A system for exhibiting in a toilet bowl CAS as in claim 3, wherein said at least one visual graphics item is an electronic paper.

7. A system for exhibiting in a toilet bowl CAS as in claim 5, wherein said transparency is a first visual graphics item disposed behind said inner face and wherein a second visual graphics item is disposed behind said transparency, and wherein said second visual graphics item is spaced apart at a distance from said transparency, and wherein said emitted light illuminates the face of said second visual graphics item and the back of said transparency.

8. A system for exhibiting in a toilet bowl CAS as in claim 1, wherein said controller further includes a memory in which sound is stored, and wherein the content of said memory is further processed by said audio generator and sounded by means of said at least one speaker.

9. A system for exhibiting in a toilet bowl CAS as in claim 1, further including a motion detector, for activating said controller.

10. A system for exhibiting in a toilet bowl CAS as in claim 1, further including a sensing device for indicating said cover being open.

11. A system for exhibiting in a toilet bowl CAS as in claim 1, further including a rechargeable battery powering said controller.

12. A showcase for exhibiting indoors, comprising:
a transparent front face;
a rear attachable wall;
at least one speaker;
at least one visual graphics item selected from a group containing text, drawings, 2D pictures, 3D pictures and any combination thereof, disposed behind said transparent face, and
a controller further comprising:
a processor for at least generating audio signals for feeding into said at least one speaker, and
at least one LED for illuminating said at least one visual graphics item.

13. A showcase as in claim 12, wherein said at least one visual graphics item is a transparency.

14. A showcase as in claim 12, wherein said at least one visual graphics item is an electronic paper.

15. A showcase as in claim 13, wherein a first visual graphics item is said transparency disposed behind said transparent face, and wherein a second visual graphics item is disposed behind said transparency, and wherein said second visual graphics item is spaced apart from said transparency, and wherein said emitted light illuminates the face of said second visual graphics item and the back of said transparency.

16. A showcase as in claim 12, further including a key for activation.

17. A method for issuing a compound message comprising:
presenting a graphical aspect of said compound message by illuminating at least one visual graphics item selected from the group containing text, drawings, 2D pictures, 3D pictures and any combination thereof, wherein said at least one visual graphics item is attached to any of the items selected from a group containing an inner face of a toilet cover, a front face of a toilet bowl and a face of a flush tank;
sounding an audible aspect of said compound message, wherein said audible aspect of said compound message includes an item from the group consisting of utterances, spoken messages, music and any combination thereof, and
wherein said illumination is activated by a controller including a processor and at least one LED, wherein said controller is installed at any item selected from a group including: said toilet cover and a seat of said toilet.
